(19) United States
(12) Patent Application Publication
(10) Pub. No.: US 2024/0293757 A1
(43) Pub. Date: Sep. 5, 2024

(54) SMART BLOCK CAPABLE OF SUPPLYING POWER AND RECOGNIZING POSITION, AND CONTROL SYSTEM FOR SAME

(71) Applicant: CREAMO INC., Seoul (KR)

(72) Inventors: Seok LEE, Seoul (KR); Gang Hyun CHO, Seongnam-si (KR)

(21) Appl. No.: 18/572,966

(22) PCT Filed: Dec. 20, 2021
(86) PCT No.: PCT/KR2021/019358

§ 371 Date: Dec. 21, 2023

(30) Foreign Application Priority Data
Jul. 13, 2021 (KR) 10-2021-0091451

(51) Int. Cl. A63H 33/04; A63H 33/08; A63H 33/26; G06F 8/41; G09B 1/16

(52) U.S. Cl. CPC A63H 33/042; A63H 33/26; G06F 8/41; A63H 33/086; A63H 2200/00; G09B 1/16

(57) ABSTRACT

Proposed are a smart block and a control system for same, wherein while enabling learning, playing, and coding experiences by providing various functions through a function block capable of transmitting and receiving data a conventional block may be easily converted to a smart block, the manufacturing cost of smart blocks may be lowered, and the power supply is simplified by enabling a specific power block coupled to a function block on the side surface to supply power to the function block, and wherein the position of each function block may exactly be identified by additionally forming a beacon block that may wirelessly transmit reference position information through the beacon module and then by receiving information on the relative position of function blocks for the reference position while coupling a function block to the side surface of a beacon block to receive information on the reference position.

### TECHNICAL FIELD

The present disclosure relates to a smart block and a control system for same and, more particularly, to a smart block and a control system capable of the power supply and position recognition, wherein while enabling learning, playing, and coding experiences by providing various functions through a function block capable of transmitting and receiving data a conventional block may be easily converted to a smart block, the manufacturing cost of smart blocks may be lowered, and the power supply is simplified by enabling a specific power block coupled to a function block on the side surface to supply power to the function block, and wherein the position of each function block may exactly be identified by additionally forming a beacon block that may wirelessly transmit reference position information through a beacon module and then by receiving information on the relative position of function blocks for the reference position while coupling a function block to the side surface of a beacon block to receive information on the reference position.

### BACKGROUND ART

Block toys may be enjoyed while building shapes, figures, etc. by fitting the blocks together, connecting or arranging several pieces made up of various three-dimensional shapes such as rectangular, cylindrical, etc. shapes, whereby various educational effects may be given to infants or children, and intelligence and creativity may be improved by assembling various models. In recent years, these block toys have evolved into smart blocks that provide functions such as IoT, and board products on which these smart blocks are placed have been developed into products having various smart functions.

However, in the case of conventional smart blocks or block products for coding education, learning or playing is performed by simply arranging, sequencing, or placing smart blocks that simply implement a specific function, and coding education also remains at the level of inputting and implementing a specific function in a specific smart block.

[Document of Related Art] Korean Patent No. 10-1915939 (registered on Oct. 31, 2018) “Smart block for infants”

Although blocks with smart wireless communication functions as well as various input and output functions are utilized to provide creative play and education in combination with conventional block toys like “smart blocks” disclosed in the above (prior patent literature), the above prior art actually does not disclose any special concepts other than the implementation of functions by connecting these smart blocks, nor does it disclose problem recognition or solutions for a coding education.

In addition, there is a problem that every smart block includes not only components for its function, but also components for the power supply and components for communication such that the unit price of smart blocks is increased and manufacturing process is complicated, making it difficult to utilize conventional blocks.

In addition, there is a difficulty in setting up various operations and performing coding for smart blocks since conventional smart blocks do not include a configuration that recognizes and specifies the exact position.

### DISCLOSURE

### Technical Problem

The present disclosure has been devised to solve the above problems.

An objective of the present disclosure is to provide a smart block, wherein a conventional block may be easily converted to a smart block, the manufacturing cost of smart blocks may be lowered, and the power supply is simplified by enabling a specific power block coupled to a function block on the side surface to supply power to the function block while enabling learning, playing, and coding experiences by providing various functions through a function block capable of transmitting and receiving data.

An objective of the present disclosure is to provide a smart block that enables efficient use and connection of smart blocks by a way that function blocks are laterally coupled to each other and allow electric power from a power block to be transmitted such that a plurality of function blocks may be connected to and powered by a single power block.

An objective of the present disclosure is to provide a smart block that enables electric power to be smoothly supplied even when smart blocks are formed in a two-dimensional multilayer by connecting power blocks in an upward and downward direction to transmit electric power.

An objective of the present disclosure is to provide a smart block wherein conventional blocks may be easily converted and used as various shapes of blocks by replacing only a lower plate and a horizontal power line may be easily replaced and inspected, by allowing the horizontal power line that transmits electric power to the side surface to be formed only in the lower plate while the function block and power block may be all composed of a main body, an upper plate, and a lower plate.

An objective of the present disclosure is to provide a smart block that may exactly identify the position of each function block not only by additionally forming a beacon block that may wirelessly transmit reference position information through the beacon module but also by coupling a function block to the side surface of a beacon block in order to receive information on the reference position and then receiving information on the relative position of function blocks for the reference position.

An objective of the present disclosure is to provide a smart block that may provide exact position information on a plurality of function blocks even with a single beacon block by coupling function blocks laterally to each other in order to transmit information on the reference position received from a beacon module and to receive information on the relative position of function blocks for the reference position.

An objective of the present disclosure is to provide a smart block that may provide exact position information even when smart blocks are formed in a two-dimensional multilayer by connecting a beacon block to another beacon block or a power block in an upward or downward direction in order to transmit position information.

An objective of the present disclosure is to provide a smart block wherein conventional blocks may be easily converted and used as various shapes of blocks by replacing only the lower plate and a horizontal communication power line may be easily replaced and inspected, by allowing the horizontal communication line that transmits position information to the side surface to be formed only in the lower plate.

An objective of the present disclosure is to provide a smart block that enables efficient configuration of blocks by allowing a beacon block to include the same power line as the power block in order to supply electric power by one beacon block.

An objective of the present disclosure is to provide a smart block control system that enables various learning, playing, and coding experiences through smart blocks by allowing various functions and operations for function blocks to be set through a user terminal.

An objective of the present disclosure is to provide a smart block control system wherein various combinations of function blocks are possible through pairing and connecting function blocks, the performing functions of function blocks may be set/modified/controlled according to a mission of learning or playing, and various learning or playing may be realized with limited function blocks through a sequence control on functions.

An objective of the present disclosure is to provide a smart block control system that may utilize smart blocks for coding learning, wherein coding work may be performed simply by dragging and dropping command entries displayed on the coding work screen in order, both the input of entries and the input of identification information may be performed in a drag-and-drop manner, the coding work may be simply performed by displaying identification information of the target smart block on the work screen and inputting identification information displayed on the work screen (or simple icon) in the middle of the entry, and the coded result may be immediately checked through a smart block product where a batch is completed.

An objective of the present disclosure is to provide a smart block control system that may identify the exact position of each function block through both identification information and reference position information via a beacon block and then perform operations of setting and coding on function blocks easily and exactly.

### Technical Solution

In order to achieve the objectives above, the present disclosure may be implemented by an exemplary embodiment having the following configurations.

According n exemplary embodiment of the present disclosure, a smart block according to the present disclosure may include a function block that is supplied with electric power and implements various functions and a power block that has a battery for storing electric power and is coupled to the side surface of the function block to supply electric power to function blocks.

In the smart block according to another exemplary embodiment of the present disclosure, the function block is formed to be able to be coupled to each other on the side surfaces, and is configured to transmit electric power supplied from one side surface to another function block on the other side surface.

In the smart block according to another exemplary embodiment of the present disclosure, the power block may be stacked in an upward and downward direction, thereby transmitting electric power.

According to another exemplary embodiment of the present disclosure, the smart block according to the present disclosure may include a main body formed with a certain internal space to form a certain volume of a block, an upper plate coupled to the upper side of the main body and having a protrusion to be coupled to an upper smart block, and a lower plate coupled to the lower side of the main body and having a coupling groove where the protrusion is inserted in order to be coupled to a lower smart block, wherein the lower plate includes a horizontal power line that allows electric power to be transmitted to a smart block on the side surface.

In the smart block according to another exemplary embodiment of the present disclosure, the power block may further include a vertical power line that transmits electric power stored in a battery in an upward and downward direction, and the vertical power line may be formed to pass through the main body, the upper plate, and the lower plate.

According to another exemplary embodiment of the present disclosure, the smart block according to the present disclosure may further include a beacon block that wirelessly transmits reference position information through a beacon module, and the function block may be coupled to the side surface of a beacon block and receive information on the reference position of the beacon block.

In the smart block according to another exemplary embodiment of the present disclosure, the function block may be formed to be able to be coupled to each other on the side surfaces and may be configured to transmit position information received from one side to a function block on the other side.

In the smart block according to another exemplary embodiment of the present disclosure, the beacon block is coupled to a beacon block or a power block in an upward and downward direction and may be configured to transmit position information.

According to another exemplary embodiment of the present disclosure, the smart block according to the present disclosure may include a main body formed with a certain internal space to form a certain volume of a block, an upper plate coupled to the upper side of the main body and having a protrusion to be coupled to an upper smart block, and a lower plate coupled to the lower side of the main body and having a coupling groove where the protrusion is inserted in order to be coupled to a lower smart block, wherein the lower plate includes a horizontal communication line that allows position information to be transmitted to a smart block on the side surface.

In the smart block according to another exemplary embodiment of the present disclosure, the beacon block may further include a vertical communication line that transmits reference position information in an upward and downward direction, and the vertical communication line is formed to pass through the main body, the upper plate, and the lower plate.

In the smart block according to another exemplary embodiment of the present disclosure, the beacon block may include a horizontal power line formed on the lower plate in order to transmit electric power to a smart block on the side surface and a vertical power line in order to transmit electric power in an upward and downward direction.

In the smart block according to another exemplary embodiment of the present disclosure, the function block may include an input block that generates and transmits various input signals, an output block that displays various output signals, and a logic block that generates and transmits control signals necessary for various logic operations.

According to another exemplary embodiment of the present disclosure, a smart block control system according to the present disclosure may include a smart block formed to be in the form of a play block implementing various functions by being coupled to each other, a control block that communicates with the smart block and transmits control information on the smart block and a user terminal that communicates with the control block and sets and controls various operations of the smart block.

In the smart block control system according to another exemplary embodiment of the present disclosure, the function block may have identification information, and include an ID module that transmits identification information and position information to the control block along with supplying power to the function block, a pairing module utilized for pairing and connecting other function blocks and a function module capable of setting or modifying a specific function.

In the smart block control system according to another exemplary embodiment of the present disclosure, a user terminal may include a pairing control module that transmits a control signal related to a pairing module of a function block and a function block to be paired and connected, a function control module that sets or modifies a specific function for the function module of a specific function block, and a sequence control module that sets a sequence related to conditions, operation order, and repetition for operations of each function block when a plurality of function blocks are operated for learning or playing.

In the smart block control system according to another exemplary embodiment of the present disclosure, the user terminal may further include an interface unit that provides a work screen for coding a control command for a control target, and a coding processing unit that compiles the content coded on the work screen of the interface unit and specifies the control target of the compiled control code.

In the smart block control system according to another exemplary embodiment of the present disclosure, the interface unit may include a first area for displaying a plurality of command entries selectable on the work screen, and a second area where the entry selected in the first area is displayed in a drag and drop manner, and the coding processing unit may include a conversion processing module for converting everyday terms into programming languages for compilation when the entry of the first area is displayed in everyday terms, a compilation processing module for compiling a plurality of entries arranged in the second area according to the arrangement order of a plurality of entries disposed in the second area, an error analysis module for analyzing errors in the control code compiled by the compilation processing module, an error display module for displaying errors on the work screen when an error exists in the control code as a result of the analysis of the error analysis module, and a control code transmission module for transmitting the control code of compiled entries to the control target when no error exists in the control code as a result of the analysis of the error analysis module.

In the smart block control system according to another exemplary embodiment of the present disclosure, the coding processing unit may include a coding target specifying module that specifies a coding target according to the selection of identification information transmitted by the ID module and the coding target specifying module may include an identification information display module that displays identification information transmitted by the ID module on the work screen, an identification information selection module that allows identification information displayed by the identification information display module to be selected as an object item of an entry or allows the corresponding identification information to be selected as a target of coding when dragged and dropped on the object item, and an identification information designation module that designates the selected identification information as a coding target for an entry.

### Advantageous Effects

The present disclosure may achieve the following effects by combining the mentioned exemplary embodiment with the configuration, combination, and usage relationship described below.

The present disclosure may have an effect that a conventional block may be easily converted to a smart block, the manufacturing cost of smart blocks may be lowered, and the power supply may be simplified by enabling a specific power block coupled to a function block on the side surface to supply power to the function block while enabling learning, playing, and coding experiences by providing various functions through a function block capable of transmitting and receiving data.

The present disclosure may have an effect that a smart block enables efficient use and connection of smart blocks by a way that function blocks are laterally coupled to each other and allow electric power from a power block to be transmitted such that a plurality of function blocks may be connected to and powered by a single power block.

The present disclosure may have an effect that a smart block may allow electric power to be smoothly supplied even when smart blocks are formed in a two-dimensional multilayer by connecting power blocks in an upward and downward direction to transmit electric power.

The present disclosure may have an effect that a conventional block may be easily converted to a smart block and used as various shapes of blocks by replacing only a lower plate and a horizontal power line may be easily replaced and inspected, by allowing the horizontal power line that transmits electric power to the side surface to be formed only in the lower plate while the function block and power block may be all composed of a main body, an upper plate, and a lower plate.

The present disclosure may have an effect that a smart block may exactly identify the position of each function block not only by additionally forming a beacon block that may wirelessly transmit reference position information through a beacon module but also by coupling a function block to the side surface of the beacon block in order to receive information on the reference position and then receiving information on the relative position of function blocks for the reference position.

The present disclosure may have an effect that a smart block may provide exact position information on a plurality of function blocks even with a single beacon block by coupling function blocks laterally to each other in order to transmit the information on the reference position received from a beacon module and to receive information on the relative position of function blocks for the reference position.

The present disclosure may have an effect that a smart block may provide exact position information even when smart blocks are formed in a two-dimensional multilayer by connecting a beacon block to another beacon block or a power block in an upward or downward direction in order to transmit position information.

The present disclosure may have an effect that conventional blocks may be easily converted to smart blocks and used as various shapes of blocks by replacing only a lower plate and a horizontal communication line may be easily replaced and inspected, by enabling the horizontal communication line that transmits position information to the side surface to be formed only in the lower plate.

The present disclosure may have an effect that a smart block may enable an efficient configuration of blocks by allowing a beacon block to include the same power line as a power block in order to supply electric power by a single beacon block.

The present disclosure may have an effect that a smart block control system may enable various learning, playing, and coding experiences through smart blocks by setting various functions and operations for function blocks through a user terminal.

The present disclosure may have an effect that various combinations of function blocks are possible through pairing and connecting function blocks, the performing functions of function blocks may be set/modified/controlled according to a mission of learning or playing, and various learning or playing may be realized with limited function blocks through a sequence control on functions.

The present disclosure may have an effect that a smart block control system may utilize smart blocks for coding learning, wherein coding work may be performed simply by dragging and dropping the command entries displayed on the coding work screen in order, the input of the entries and identification information may be performed in a drag-and-drop manner, command entries may be displayed in everyday terms to enable coding experiences for children, the coding work may be simply performed by displaying identification information of the target smart block on the work screen and inputting identification information (or simple icon) in the middle of the entry displayed on the work screen, and the coded result may be immediately checked through a smart block product where a batch is completed.

The present disclosure may have an effect that a smart block control system may identify the exact position of each function block through both identification information and reference position information via a beacon block and then operations of setting and coding on function blocks are performed easily and exactly.

### DESCRIPTION OF DRAWINGS

FIG. 1 is a block diagram of a smart block according to an exemplary embodiment of the present disclosure.

FIG. 2 is a block diagram of a power block of FIG. 1.

FIG. 3 is a bottom view and a plan view of a power block of FIG. 2.

FIG. 4 is a reference diagram showing an example of a power block.

FIG. 5 is a block diagram of a smart block according to another exemplary embodiment of the present disclosure.

FIG. 6 is a block diagram of a beacon block of FIG. 5.

FIG. 7 is a bottom view and a plan view of a beacon block of FIG. 5.

FIG. 8 is a reference diagram showing an example of a beacon block.

FIG. 9 is a reference diagram showing an actual modeling example of a lower plate of a beacon block.

FIG. 10 is a reference diagram showing another example of an upper surface and a lower surface of a smart block.

FIG. 11 is a reference diagram showing an example of a function block.

FIG. 12 is a block diagram of a smart block control system according to another exemplary embodiment of the present disclosure.

FIG. 13 is a block diagram showing a configuration of a function block of FIG. 12.

FIG. 14 is a block diagram showing a configuration of a user terminal of FIG. 12.

FIG. 15 is a reference diagram showing a work screen of an interface unit used in coding education using a smart block.

FIG. 16 is a block diagram showing a configuration of a coding processing unit.

FIG. 17 is a schematic diagram showing identification information of a function block displayed through an interface unit.

### BEST MODE

Hereinafter, preferred exemplary embodiments of a smart block capable of the power supply and position recognition and a control system for same according to the present disclosure will be described in detail with reference to the accompanying drawings. Hereinafter, in describing the present disclosure, when it is determined that a detailed description of a known function or configuration may unnecessarily obscure the gist of the present disclosure, the detailed description thereof will be omitted. Throughout the specification, when a part “includes” a component, it means that other components may be further included rather than excluding other components unless otherwise stated, and terms such as “unit”, “module”, and the like described in the specification mean a unit that processes at least one function or operation, which may be implemented by hardware or software or a combination of hardware and software.

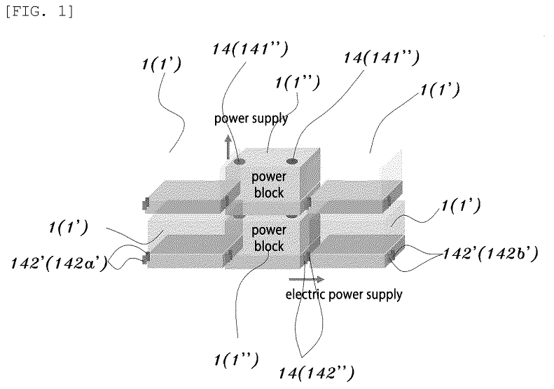

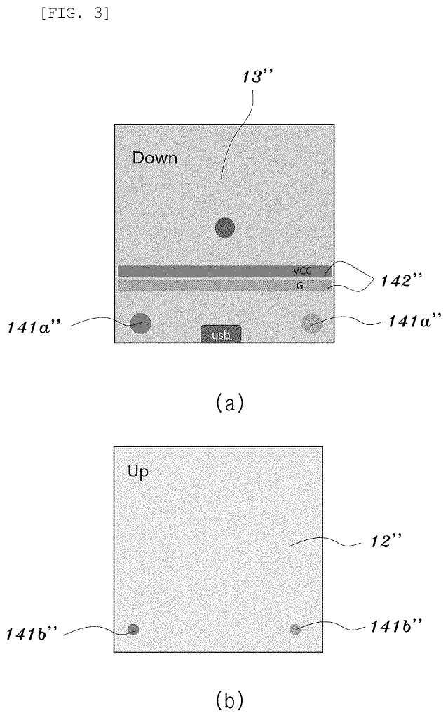

When explaining a smart block capable of supplying power and recognizing a position according to an exemplary embodiment of the present disclosure using FIGS. 1 to 4, the smart block 1 may include a function block 1′ that is supplied with electric power and implements various functions and a power block 1″ that has a battery for storing electric power and is coupled to the side surface of the function block 1′ to supply electric power to function blocks 1′.

The function block 1′ may refer to a block where smart functions are added to blocks commonly used for learning or playing and a smart function may refer to a function that performs communication functions such as IoT, as well as functions that generate and display data such as various input and output signals. The function block 1′ may be formed to perform various functions such as outputting a sound from a specific character or measuring temperature and humidity and for this to include various components and circuits such as a communication module and an operation module (CPU), and in particular, functions of the function block 1′ may be performed only when electric power is supplied. Therefore, conventional smart blocks have to be supplied with electric power by configuring a battery in each smart block, so there is a problem that the manufacturing cost of the smart block is increased and the production is cumbersome. Accordingly, in the case of the function block 1′ according to the present disclosure, only the minimum configuration to perform a function is formed inside and electric power to the function block 1′ is supplied through a separate power block 1″, thereby lowering the unit price for manufacturing the function block 1′ and making the production simple. In particular, the function block 1′ may be coupled to the side surface of the power block 1″ to be supplied with electric power and allow a plurality of the function blocks 1′ to be coupled to both sides of a single power block 1″ by being coupled to the side surface between a plurality of function blocks 1′ to transmit electric power, thereby simplifying the supply of electric power to a plurality of function blocks 1′. In addition, the function block 1′ may include a main body 11, an upper plate 12, and a lower plate 13 as described later, and a configuration for receiving and transmitting electric power and a configuration for controlling the function block 1′ are formed only in the lower plate 13, so that conventional blocks may be easily converted to the function block 1′ only by replacing the lower plate 13, and the shape of the smart block 1 may be freely changed.

The power block 1″ may be configured to supply electric power to the function blocks 1′, wherein a battery is formed therein to store electric power and supplies the stored electric power to the function blocks 1′. The power block 1″ may be coupled ambilaterally to the function block 1′ to supply electric power and the function blocks 1′ coupled to both sides of the power block 1″ may be coupled to one another in multiple to transmit electric power supplied from the power block 1″ so that a plurality of function blocks 1′ on both sides may be supplied with electric power by a single power block 1″. In addition, the power block 1″ may be coupled in an upward and downward direction to transmit electric power, and the power block 1″ in the form of conventional blocks may be coupled in an upward and downward direction. Accordingly, the power block 1″ may be stacked and coupled in an upward and downward direction and as shown in FIG. 1, the function blocks 1′ may be coupled to both sides of each power block 1″ stacked in an upward and downward direction to be supplied with electric power, thereby allowing the function blocks 1′ to be coupled in a two-dimensional form to form a block assembly. Accordingly, the present disclosure may allow the block assembly to be formed with a minimum number of power blocks 1″ while allowing the block assembly to be formed with various shapes in two dimensions. In addition, the power block 1″ is formed to be stacked in an upward and downward direction to transmit electric power and electric power may be supplied from another power block 1″ and transmitted to function blocks 1′ even when the battery of a specific power block 1″ is exhausted, so that functions of the entire function blocks 1′ may be maintained for a long time. In addition, a configuration of the power block 1″ including a battery in the electric power transmission is also formed in the lower plate 13, so that conventional blocks may be easily converted to various types of blocks like the function block 1′ while being easily replaced even when the battery is exhausted.

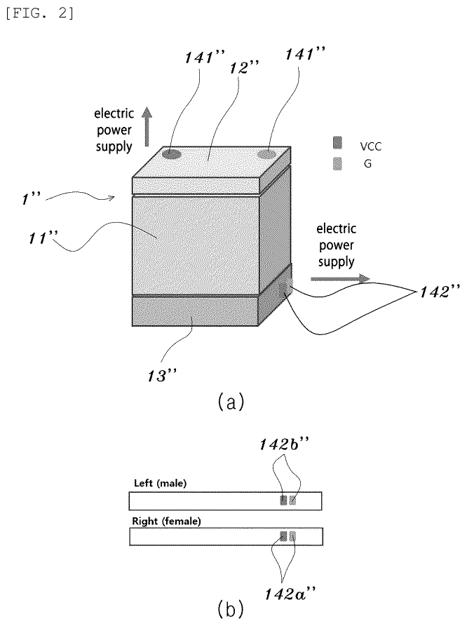

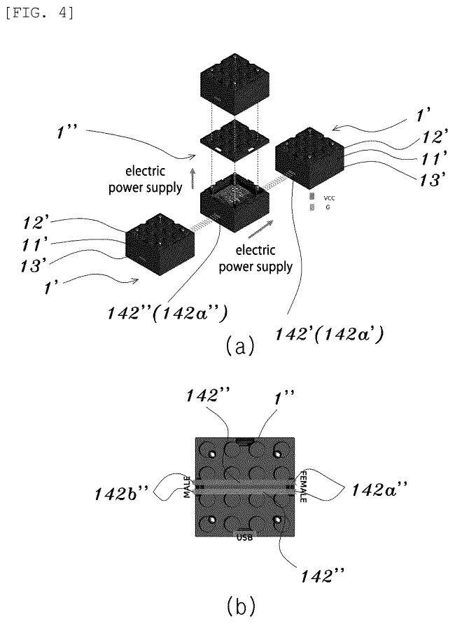

Meanwhile, as shown in FIGS. 2 and 4, the smart block 1 may include a main body 11 formed with a certain internal space to form a certain volume of a block, an upper plate 12 coupled to the upper side of the main body 11 and having a protrusion 121 to be coupled to an upper smart block 1, and a lower plate 13 coupled to the lower side of the main body 11 and having a coupling groove 131 where the protrusion 121 is inserted in order to be coupled to a lower smart block 1. In this case, the upper plate 12 and the lower plate 13 may respectively include protrusions 121 and coupling grooves 131 that are detachably coupled to each other like regular blocks, so that the upper plate 12 and the lower plate 13 of smart blocks 1 may be coupled to each other.

Both the function block 1′ and the power block 1″ may be formed with the same form of the main body 11, the upper plate 12, and the lower plate 13, and a configuration for supplying electric power, a configuration for controlling functions, and a configuration for transmitting data are all formed in the lower plate 13, so that various forms of the function block 1′ and the power block 1″ may be formed and conventional blocks may be easily converted to the smart block 1 by changing only the lower plate 13.

In addition, the smart block 1 may have an electric power line 14 formed therein for transmitting electric power and only the horizontal power line 142′ for transmitting electric power in a horizontal direction may be formed in the lower plate 13′ in the case of the function block 1′, and the horizontal power line 142′ may have a female terminal 142a′ and a male terminal 142b′ formed on both sides to be coupled to the male terminal 142b and female terminal 142a of another smart block 1 respectively. At this time, the horizontal power line 142′ may be formed as a pair of two lines, VCC and G, and may be in contact with the power block 1″ or another function block 1′ to be supplied with electric power and transmit the supplied electric power to other function blocks 1′.

Furthermore, the power block 1″ may also have a horizontal power line 142″ formed in the same way as the function block 1′, and have a female terminal 142a″ and a male terminal 142b″ such that the power block is coupled and contacted to each of the male terminal 142b′ and female terminal 142a′ of the function block 1′ on both sides to transmit electric power and the horizontal power line 142″ is connected to the battery to be supplied with electric power.

In addition, the smart block 1 may include a vertical power line 141 that transmits electric power in a vertical direction, and the vertical power line 141 is formed only in the power block 1″. Accordingly, electric power may be transmitted between the power blocks 1″ that are stacked vertically, and the vertical power line 141″ may be formed to pass through the upper plate 12″, the main body 11″, and the lower plate 13″. Like the horizontal power line 142″, the vertical power line 141″ may also have a female terminal 141a′ and a male terminal 141b′ formed on the upper and lower sides, so that there is a contact and electric power transmission between the upper and lower vertical power lines 141″ and two lines of VCC and G may be formed in a pair.

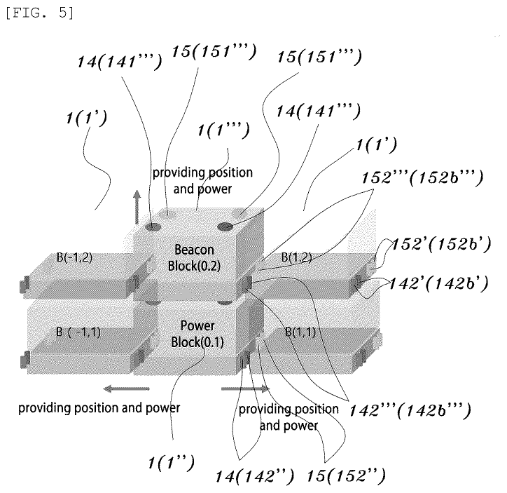

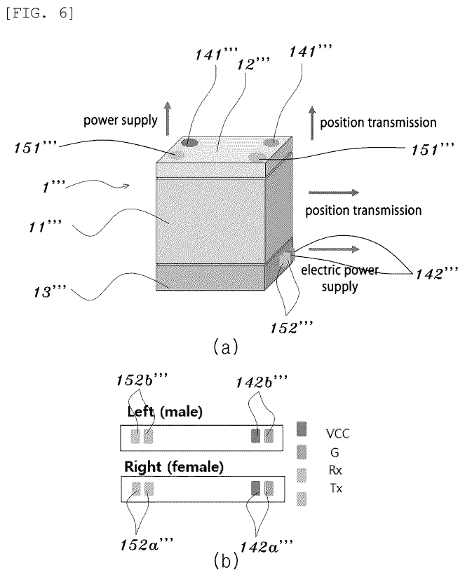

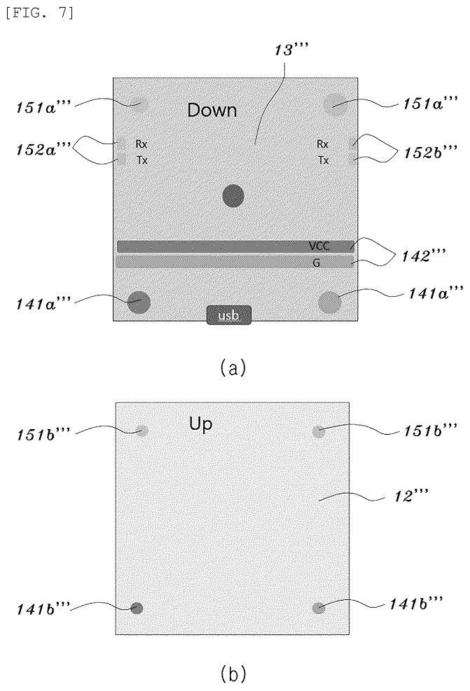

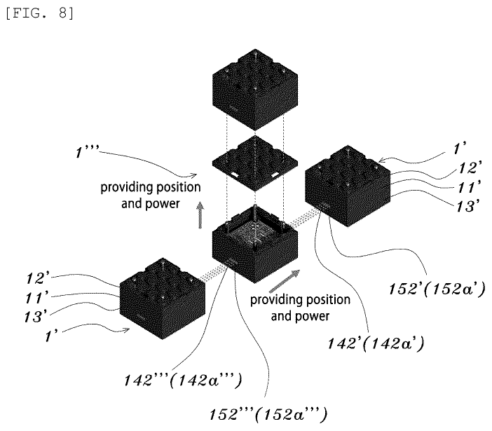

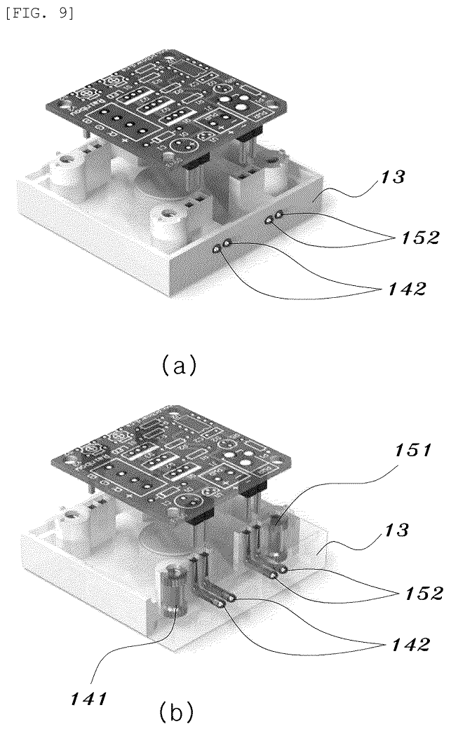

When explaining a smart block 1 according to another exemplary embodiment of the present disclosure referring to FIGS. 5 to 10, the smart block 1 may further include a beacon block 1′″ that wirelessly transmits reference position information through a beacon module.

Like the function block 1′ and the power block 1″, the beacon block 1′″ may be formed with a main body 11′″, an upper plate 12′″, and a lower plate 13′″, and may further include a beacon module therein to transmit the reference position information to a neighboring smart block 1 and a control device for controlling the smart block 1. In this case, the control device may be a smart terminal where a separate control block, an application, or the like is installed. The beacon block 1′″ may have a battery therein to store electric power in the same way as the power block 1″, and may be formed to only add a beacon module and a configuration for transmitting position information to the power block 1″. Also, the beacon block 1′″ may be formed to transmit electric power by removing only a battery in the power block 1″. Therefore, the beacon block 1′″ may be configured to transmit the position information together while supplying electric power. The beacon block 1′″ may be formed to enable wireless recognition through the beacon module and the beacon module may store recognition information such as an ID for each beacon block 1′″ and reference position information. Like the power block 1″, the beacon block 1′″ may be coupled to the function block 1′ on both sides and position information based on the beacon block 1′″ may be sent to the coupled function block 1′, thereby identifying the exact position of the function block 1′ on the basis of the beacon block 1′″. Also, like the power block 1″ the beacon block 1′″ may be formed to be stacked in an upward and downward direction and position information may be transmitted in an upward and downward direction. Therefore, the beacon block 1′″ may transmit position information according to the reference position not only on both sides but also in an upward and downward direction, thereby generating exact position information of each function block 1′ even for a two-dimensional structure of the smart blocks 1.

As an example, the beacon block 1′″ may be set to have a coordinate information of (x, y) as the reference position information and may be configured to transmit position information where the x coordinate increases by 1 to the right and the x coordinate decreases by 1 to the left for the stored reference position information while transmitting position information where the y coordinate increases by 1 to the top and the y coordinate decreases by 1 to the bottom.

When explaining an example of transmitting position information by the beacon block 1′″ referring to FIG. 5, the reference position information of the beacon block 1′″ may be stored as (0,2) and the position information wherein the function block 1′ on the right side of the beacon block 1′″ is in a form of (1,2) and the function block 1′ on the left side thereof is in a form of (−1,2) may be transmitted on the basis of the beacon block 1′″. The position information of (0,1) may be transmitted to the power block 1″ below the beacon block 1′″ and the position information of (1,1) may be transmitted to the function block 1′ on the right side of the power block 1″ while the position information of (−1,1) may be transmitted to the function block 1′ on the left side of the power block 1″. Accordingly, the user may exactly identify the position of the function blocks 1′ formed in multiple layers and multiple rows on the basis of the beacon block 1′″ whereby operations for each function block 1′ may be exactly and easily set through the user terminal or the like.

In addition, when the beacon block 1′″ is applied, the beacon block may be formed to enable data communication by means of contact for transmitting the position information or for the power block 1″ and the function block 1′.

Accordingly, the smart block 1 may further include a data communication line 15 to transmit reference position information from the beacon block 1′″, and all of the beacon block 1′″, the function block 1′, and the power block 1″ may include the data communication line 15.

In this case, the data communication line 15 may be formed to enable transmission of information via serial communication and may include a vertical communication line 151 capable of transmitting information in a vertical direction and a horizontal communication line 152 capable of transmitting information in a horizontal direction, wherein only the horizontal communication line 152′ is formed in the function block 1′ so that the position information received from the beacon block 1′″ may be transmitted to the function block 1′ on the other side. In this case, the horizontal communication line 152′ of the function block 1′ may also be formed together with the horizontal power line 142′ in the lower plate 13′, and the horizontal communication line 152′ may be formed with female terminals 152a′ and male terminals 152b′ on both sides respectively like the horizontal power line 142′. Accordingly, the function block 1′ may transmit the position information received from one side to the other side, and may receive the position information from the beacon block 1′″ on one side or may receive the position information by connecting to another function block 1′ that has received the position information. In this case, the horizontal communication line 152′ may have two lines, Rx and Tx, formed as a pair.

In addition, the beacon block 1′″ and the power block 1″ are formed with a horizontal communication line 152″ in the same way as the function block 1′ and have a female terminal 152a″ and a male terminal 152b″, thereby being coupled and contacted to each of the male terminals 152b′ and female terminals 152a′ on both sides of the function block 1′ to transmit position information and to receive position information stored in the beacon module of the beacon block 1′″.

In addition, the beacon block 1′″ and the power block 1″ may be further formed with vertical communication lines 151′″, 151″, so that position information may be transmitted between the beacon blocks 1′″ and the power block 1″ which are stacked vertically. In this case, the vertical communication lines 151′″, 151″ may be formed to pass through the upper plate 12, the main body 11, and the lower plate 13 like the vertical power lines 141′″, 141″. Like the horizontal power lines 152′″, 152″, the vertical communication lines 151′″, 151″ may have female terminals 151a′″, 151a″ and male terminals 151b′″, 151b″ formed on the upper and lower sides, thereby enabling contact and information transmission between the upper and lower vertical communication lines 151′″, 151″, and forming the two lines of Rx, Tx as a pair.

Furthermore, the beacon block 1′″ may include the same power line 14′″ as the power block 1″, and may include a vertical power line 141′″ and a horizontal power line 142′″. Therefore, the beacon block 1′″ alone may be used to form a multi-layer block so that electric power may be supplied along with the transmission of position information and the beacon block 1′″ and the power block 1′″ may be stacked alternately as shown in FIG. 5 to further reduce the unit price for constructing blocks by using beacon blocks 1′″ in part.

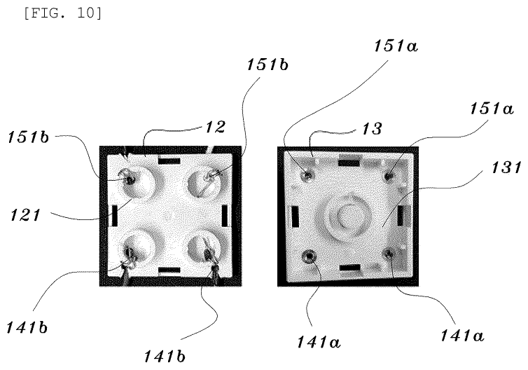

Meanwhile, as shown in FIG. 10, the function block 1′ may include an input block 101′ that generates and transmits various input signals, an output block 102′ that displays various output signals, and a logic block 103′ that generates and transmits control signals necessary for various logical operations.

The input block 101′ may be configured for the function block 1′ itself to generate various input signals and to interwork with other smart blocks or user terminals and as a representative example, the input block 101′ may include a switch block for generating a specific start signal or stop signal, a dial block for generating a control signal for a specific intensity, a temperature, humidity or light block for generating and measuring data such as temperature, humidity or illumination, or a camera block for photographing and transmitting data such as a video.

The output block 102′ may be configured for the function block 1′ itself to generate various output signals and to interwork with other smart blocks or user terminals and as a representative example may include a speaker block for generating specific sound signals, and a LED block for displaying specific letters or numbers and additionally a motor block for generating rotational driving force may also be included in the output block 102′.

The logic block 103′ may be configured for the function block 1′ itself to generate and transmit various control signals necessary for various logical operations (including operations for algorithm implementation or coding implementation) and as representative examples may include an operation symbol block capable of implementing operation symbol signals necessary for math operations such as +,−, ×, ÷, =, a case block capable of implementing signals such as ‘if’, ‘true’ or ‘false’, and other various blocks capable of generating and transmitting signals necessary to implement various mathematical and logical operations.

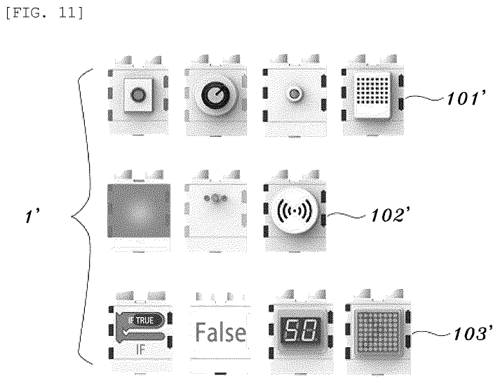

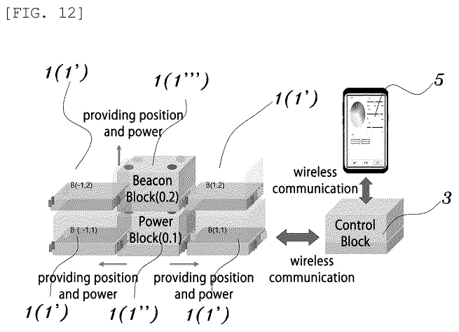

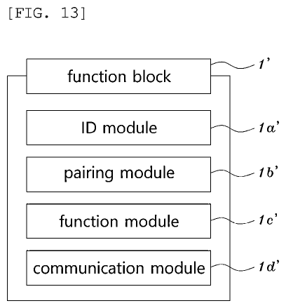

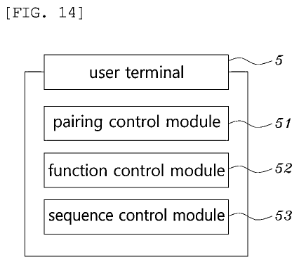

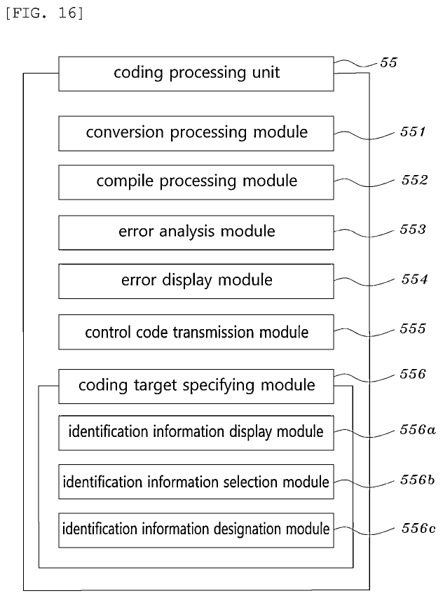

When explaining a smart block control system according to another exemplary embodiment of the present disclosure referring to FIGS. 11 to 17, the smart block control system may include a smart block 1 formed to be in a form of a play block implementing various functions by being coupled to each other, a control block 3 that communicates with the smart block 1 and transmits control information on the smart block 1 and a user terminal 5 that communicates with the control block 3 and sets and controls various operations of the smart block 1.

In particular, the smart block control system may receive position information of each function block 1′ on the basis of the beacon block 1′″ through the beacon block 1′″ such that it is possible to identify the exact position of the function blocks 1′ and various settings for the function blocks 1′ may be exactly and easily made. In addition, the smart block 1 may be formed to have various functions in order to broaden the use of the function blocks 1′ as various learning or teaching tools, and may include an ID module 1a′ including identification information, a pairing module 1b′ utilized for pairing and connecting other function blocks 1′, a function module 1c′ capable of setting or modifying a specific function and a communication module 1d′ for transmitting and receiving data.

The ID module 1a′ may be configured to include an unique identification information of the function block 1′ itself and configured to specify the unique identification information or function of each of a plurality of function blocks 1′ for performing algorithmic education or coding education using a plurality of function blocks 1′ variously utilized in the present disclosure, thereby providing the unique identification information of the function block 1′ itself. The ID module 1a′ may transmit the automatically stored identification information along with the electric power supply for the functional block 1′. In addition, the ID module 1a′ may transmit position information received from the beacon block 1′″ to the control block 3 or the user terminal 5 along with identification information of the function block 1′ and through this, the operation and function for each function block 1′ may be exactly set.

The pairing module 1b′ may be configured to be used for pairing and connecting function blocks 1′, where pairing and connecting a plurality of function blocks 1′ that may be interconnected and operated among the plurality of function blocks 1′ may be necessary to perform a specific function such as outputting according to inputting for performing algorithmic education or coding education using a plurality of function blocks 1′ variously utilized in the present disclosure, and configured to be utilized to pair and connect the function blocks 1′ that are to be used and operated in interconnection with each other, thereby identifying the target function block 1′ to be paired and connected and performing a function of pairing and connecting the target function blocks 1′ using Bluetooth or the like.

The function module 1c′ is configured to enable a specific function of the function block 1′ to be set or modified and in the case of the function module 1c′ it is possible by the user terminal 5 to set and modify a specific function of function block 1′ to be performed according to the needs of the user because it is possible to perform various learning or play activities even within the limited number of function blocks 1′ only when function values or condition values performed by the block may be able to be set and modified in various ways depending on the content of the target learning or playing particularly in the case of the logic block 103′ (also applicable to the input block 101′ or the output block 102′ as necessary) among the function blocks 1′ used in the present disclosure.

The communication module 1d′ may be configured to be utilized for transmitting and receiving data and to be used to transmit and receive data of the function block 1′ and the control block 3, and various communication methods such as Bluetooth may be used for this purpose.

The control block 3 is configured to be connected to the smart block 1 and the user terminal 5 through wired or wireless communication, preferably wireless communication to enable data transmission between the smart block 1 and the user terminal 5 and may transmit various operations and control information for the smart blocks 1 to each smart block 1. The control block 3 may also be formed in the form of a general block to be coupled and may receive position information, identification information, and the like of the smart blocks 1 and transmit to the user terminal 5, and transmit operation information, control information, and the like for the function blocks 1′ set from the user terminal 5 to the function blocks 1′.

The user terminal 5 is configured to set various operations and control information for the function blocks 1′ and perform coding, and applicable may be various smart terminals capable of wireless communication such as PCs, smartphones, and tablets and having various input devices formed therein. Specifically, The user terminal 5 may include a pairing control module 51 that transmits a control signal related to a pairing module 1b′ of a function block 1′ and a function block 1′ to be paired and connected, a function control module 52 that sets or modifies a specific function for a function module 1c′ of a specific function block 1′, and a sequence control module 53 that sets a sequence related to conditions, operation order, and repetition for operation of each function block 1′ when a plurality of function blocks 1′ is operated for learning or playing.

The pairing control module 51 is configured to transmit a control signal related to the function block 1′ to be paired and connected and the pairing module 1b′ of the function block 1′, and the user may control a pairing connection between the functional blocks 1′ that may be operated in interconnection among a plurality of function blocks 1′ in order to perform a specific function such as an outputting according to an inputting for performing algorithmic education or coding education using a plurality of function blocks 1′ variously utilized in the present disclosure by generating and transmitting a substantial control signal for the pairing module 1b′ in the function block 1′.

The function control module 52 is configured to set or modify a specific function for the function module 1c′ of the specific function block 1′ and by generating and transmitting a substantial control signal for the function module 1c′ in the function block 1′ described above it is possible to perform various learning or play activities even within the limited number of function blocks 1′ only when function values or condition values performed by the corresponding block may be able to be set and modified in various ways depending on the content of the target learning or playing.

The sequence control module 53 may be configured to set operation conditions, operation order, and repetition-related sequences for each function block 1′ when operating the function block 1′ for learning or playing and the target function block 1′ actually has to operate in a certain order so that some functions are operated first and some functions are operated afterward, such that a corresponding mission may be accomplished by successive operation of blocks and gears in accordance with the targeted learning content, thereby setting operation conditions, operation order, and sequences related to whether to repeat for each of the functional blocks 1′ through the sequence control module 53 after setting for the necessary functions of function block 1′ used or paired and connected for inputting and outputting between the target function blocks 1′ for specific learning or playing by the pairing control module 51 and the function control module 52.

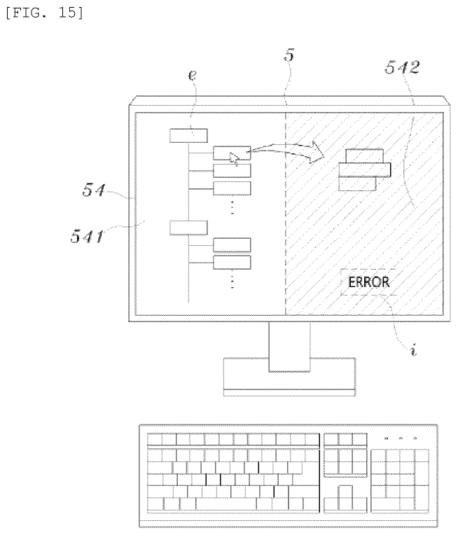

Meanwhile, the user terminal 5 may utilize the function blocks 1′ for coding learning as shown in FIGS. 15 to 17, and in this case, the user terminal 5 may further include an interface unit 54 that provides a work screen for coding a control command for a control target, a coding processing unit 55 that compiles the content coded on the work screen of the interface unit 54 and specifies the control target of the compiled control code.

The interface unit 54 is configured to provide a work screen for coding a control command of the function block 1′, and various menus such as a command entry may be displayed on the work screen. The interface unit 54 may extract menu information and frame information of the work screen stored in the user terminal 5 and display the same on a display device, and may include various display devices such as a liquid crystal display (LCD) and an organic light emitting diode (OLED) that provide a work screen. In addition, the interface unit 54 may include various input means such as a keyboard and a mouse capable of inputting a command on the work screen.

The interface unit 54 may display a plurality of selectable command entries ‘e’ in the first area 541 of the work screen displayed on a display device as shown in FIG. 15. The command entry ‘e’ may be formed to be user-friendly.

The entry may represent one sentence (technical term) in a program, and in principle, the sentence of the program should be written using various grammar and phrases specified in the corresponding programming language. However, it is difficult for general users, especially younger people, who have not learned a programming language professionally, to learn grammar and phrases used only in programming languages. The command entry ‘e’ appearing in the present specification may include grammar or phrases specified in a programming language. Alternatively, for the user's convenience, the command entry ‘e’ in the present specification may be a conversion of complex grammar or rules into everyday terms.

The interface unit 54 may display the entry ‘e’ in the first area 541 of the screen so that the user may easily find an entry ‘e’ the user wants. A left area of a vertical dotted line drawn in the center of the work screen in FIG. 15 may correspond to the first area 541. The interface unit 54 may set a second area 542 on the work screen where the entry ‘e’ selected in the first area 541 is dragged and dropped. A right area of the vertical dotted line in the center of the work screen may correspond to the second area 542.

The coding processing unit 55 may be configured to compile the content coded on the work screen of the interface unit 54 and to specify a control target of the compiled control code and operations of the function block 1′ may be carried out according to the coding by converting into a control code recognizable by the function block 1′, and then by transmitting to the function block 1′. The coding processing unit 55 may compile a plurality of entries ‘e’ disposed in the second area 542 according to the arrangement order of a plurality of entries ‘e’ disposed in the second area 542 and may precede the process of converting a plurality of entries ‘e’ into a programming language when the entry ‘e’ is displayed in a general language different from the programming language. In addition, the coding processing unit 55 may analyze errors in the control code where the entry ‘e’ is compiled and when an error exists, the error may be displayed so that the error in the coding may be immediately identified. When there is no error, the coding processing unit 55 may transmit the control code to the specified function block 1′, so that operations of the function block 1′ according to the control code may be performed. In addition, the coding processing unit 55 may specify a control target of the compiled control code, display identification information transmitted from the function block 1′ on the work screen, and specify the function block 1′, that is, a target to be controlled according to the selection of identification information, so that coding may be performed for the specified function block 1′. To this end, the coding processing unit 55 may include a conversion processing module 551, a compilation processing module 552, an error analysis module 553, an error display module 554, a control code transmission module 555, and a coding target specifying module 556.

The conversion processing module 551 is configured to convert an entry ‘e’ displayed in a general language into a programming language and when the entry ‘e’ is expressed in a general everyday term, the compilation may be performed by converting the entry ‘e’ into a programming language for users such as younger generation who do not know a programming language.

The compilation processing module 552 is configured to compile an entry ‘e’ and then to generate a control code and the compilation may be performed according to the arrangement order of a plurality of entries ‘e’ disposed in the second area 542. For example, an entry ‘e’ may include a major category and a sub-category, and the major category may include execution conditions and execution contents. The sub-category such as ‘if pressing ˜ button’ or ‘if pressing ˜ button three times’ may be added to an execution condition in a tree form, and a sub-category such as ‘rotate ˜ motor 10 times’ and ‘rotate ˜ motor as much as 30 degrees’ may be added to an execution content. Therefore, the compilation processing module 552 may compile these entries ‘e’ to generate control code and transmit the generated control code to each function block 1′, so that operations according to the entry ‘e’ may be performed in the function block 1′.

The error analysis module 553 may be configured to analyze errors in the compiled control code through the compilation processing module 552 and may display unexecutable control codes in order to notify of an error in coding.

The error display module 554 may be configured to display an error on the work screen when the control code is analyzed as having an error by the error analysis module 553 and an error ‘i’ may be displayed in the form of ‘ERROR’ as shown in FIG. 15.

The control code transmission module 555 may be configured to transmit the compiled control code to the function block 1′ and may enable the function block 1′ to be operated according to the transmitted control code. In particular, the control code transmission module 555 may enable the function block 1′ to be operated smoothly by transmitting a control code only when an error is not detected by the error analysis module 553 and may transmit the control code for the function block 1′ specified by the coding target specifying module 556, so that exact coding and operations may be performed even for a plurality of function blocks 1′.

The coding target specifying module 556 may be configured to specify the function block 1′ to be coded and may enable exact coding and operations of each function block 1′ by specifying each function block 1′ on which coding is to be performed when a plurality of function blocks 1′ are to be operated. To this end, the coding target specifying module 556 may include an identification information display module 556a that receives identification information transmitted from each function block 1′ and displays the same on the work screen, an identification information selection module 556b that selects identification information on the work screen, and an identification information designation module 556c that designates a function block 1′ to be controlled according to the selection of identification information.

For example, when there are three function blocks 1′ where a button is installed, a selection problem may arise as to which button of the function block 1′ should be specified and input, so that identification information of each function block 1′ is necessary in order to solve the selection problem. However, when a paper manual in which photos of a plurality of function blocks 1′ and identification information are written together is provided, the user may have to find a photo of the preferred function block 1′ in the manual in which photos of a plurality of function blocks 1′ and identification information are written, memorize identification information matched to the photo of the function block 1′, and input identification information in the object field of the entry, thereby making the task very inconvenient and making it difficult to exactly identify the object of identification. When the user accidentally inputs identification information of a function block 1′ that is not in a ready state, that is, not assembled to another block, the corresponding entry will not work normally.

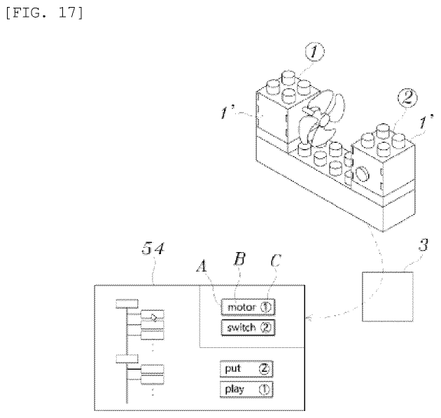

For example, as shown in FIG. 17, the user may assemble a block with a function block 1′ (1) where a motor is installed and a function block 1′ 2 where a button is installed. Thereafter, The user may then perform a coding task to implement an algorithm that rotates a motor (including the motor shaft) installed in the function block 1′ (1) when the button on the function block 1′ 2) is pressed. The user may find ‘if pressing ˜ button’ among the entries displayed in the first area 541 of the work screen as an execution condition and may drag and drop the entry to the second area 542 and may find ‘rotate ˜ motor 10 times’ among the entries as an execution content and may place it below “if pressing ˜ button” disposed in the second area 542.

In this case, identification information of the function block 1′ should be input in the object item indicated by ‘˜’ in ‘if pressing ˜ button’. Similarly, identification information of the function block 1′ should also be input in the object item indicated by ‘˜’ in ‘rotate ˜ motor 10 times’. When identification information is provided in a paper manual, the user should manually search the manual to find identification information of the function block 1′. In addition, it may be difficult to distinguish which of a plurality of function blocks 1′ where a motor is installed is the function block 1′ assembled by the user.

In FIG. 17, identification information of the function block 1′ \textcircled{1} where a motor is installed should be input to the object item indicated by ‘˜’ in ‘rotate ˜ motor 10 times’ (indicated as ‘play’ in the drawing). When identification information of another function block 1′ where a motor is installed is input in the corresponding object item, the motor and pinwheel installed in the function block 1′ \textcircled{1} in FIG. 17 may not be rotated.

In FIG. 17, identification information of the function block 1′ \textcircled{2} where a button is installed should be input to the object item indicated by ‘˜’ in ‘if pressing ˜ button’ (indicated as ‘Put’ in the drawing). When identification information of another function block 1′ where a button is installed is input in the corresponding object item, the motor may not be rotated no matter how many the button of function block 1′ \textcircled{2} in FIG. 17 is pressed. In this case, the user has to endure the inconvenience of having to search for identification information of the function block 1′ \textcircled{1} or the function block 1′ \textcircled{2} again in the manual.

Therefore, the coding target specifying module 556 may receive identification information of the object that is ready to receive a control code and may display the same on the work screen through the identification information display module 556a in order to suppress the increase in user fatigue.

The function block 1′ may be supplied with electric power by the power block 1″ and the powered function block 1′ may automatically transmit the identification information to the user terminal 5 to be displayed on the work screen by the identification information display module 556a. Meanwhile, when only a pure identification information such as a unique number is displayed on the work screen, it may be difficult for the user to determine which function block 1′ the corresponding identification information represents on the work screen, so that an identification information A may be displayed together with a category information B indicating a type of function block 1′ such as ‘motor’ and ‘switch’, and a unique number C unique to the function block 1′ such as ‘\textcircled{1}’ and ‘\textcircled{2}’ in order to easily determine which function block 1′ identification information displayed on the work screen represents. Although not shown in FIG. 17, the position information of each function block 1′ designated by the beacon block 1′″ may be displayed together with the identification information A on the work screen and through this, operations may be set by exactly identifying the position of each function block 1′ on the basis of the beacon block 1′″. In addition, when identification information is selected or the identification information is dragged and dropped on the object item in a state when the object item of the entry to be coded on the work screen is selected, the identification information may be input in the object item by the identification information selection module 556b, and the input identification information may be registered and stored as identification information of a control target for the corresponding entry by the identification information designation module 556c. At this time, identification information displayed on the work screen may be proved to be used for the block assembly, the entry where identification information is input may be guaranteed to operate in the corresponding function block 1′, and the user may review operations of the block assembly and modify the coding content according to user's preferred direction.

In the above, various exemplary embodiments of the present disclosure have been described, but these exemplary embodiments are only examples of implementing the technical idea of the present disclosure, and any modifications or changes should be interpreted as belonging to the scope of the present disclosure as long as the technical idea of the present disclosure is implemented.

### DESCRIPTION OF REFERENCE NUMERALS

1: smart block 1′: function block 101′: input block
102′: output block 103′: logic block 1a′: ID module
1b′: pairing module 1c′: function module 1d′: communication module
1″: power block 1′″: beacon module 11: main body
12: upper plate 121: protrusion 13: lower plate
131: coupling groove 14: electric power line 141: vertical power line
141a: female terminal 141b: male terminal 142: horizontal power line
142a: female terminal 142b: male terminal 15: data communication line
151: vertical communication line 151a: female terminal 151b: male terminal
152: horizontal communication line 152a: female terminal 152b: male terminal
3: control block 5: user terminal 51: pairing control module
52: function control module 53: sequence control module 54: interface unit
55: coding processing unit 551 processing module 551: conversion 552: compile processing module
553: error analysis module 554: error display module 555: control code transmission module
556: coding target specifying module 556a: identification information display module 556b: identification information selection module
556c: identification information designation module
A: identification information B: category information
C: unique number

1. A smart block, comprising:
a function block that is supplied with electric power and implements various functions; and
a power block that has a battery for storing electric power and is coupled to a side surface of the function block to supply electric power to the function block.

2. The smart block of claim 1, wherein the function block is formed to be able to be coupled to each other on the side surfaces, and is configured to transmit electric power supplied from one side surface thereof to another function block on the other side surface thereof.

3. The smart block of claim 2, wherein the power block is stacked in an upward and downward direction, thereby transmitting electric power.

4. The smart block of claim 3, comprising:
a main body formed with a certain internal space to form a certain volume of a block;
an upper plate coupled to an upper side of the main body and having a protrusion to be coupled to an upper smart block; and
a lower plate coupled to a lower side of the main body and having a coupling groove where the protrusion is inserted in order to be coupled to a lower smart block,
wherein the lower plate includes a horizontal power line that allows electric power to be transmitted to another smart block on the side surface thereof.

5. The smart block of claim 4, wherein the power block further comprises a vertical power line that transmits electric power stored in a battery in an upward and downward direction,
wherein the vertical power line is formed to pass through the main body, the upper plate, and the lower plate.

6. The smart block of claim 1, further comprising a beacon block that wirelessly transmits a reference position information through a beacon module,
wherein the function block is coupled to a side surface of the beacon block and receive the reference position information of the beacon block.

7. The smart block of claim 6, wherein the function block is configured to be able to be coupled to another function block at side surfaces thereof and is configured to transmit a position information received from one side thereof to the other function block on the other side thereof.

8. The smart block of claim 7, wherein the beacon block is coupled to another beacon block or the power block in an upward and downward direction and is configured to transmit the position information.

9. The smart block of claim 8, comprising:
a main body formed with a certain internal space to form a certain volume of a block;
an upper plate coupled to an upper side of the main body and having a protrusion to be coupled to an upper smart block; and
a lower plate coupled to a lower side of the main body and having a coupling groove where the protrusion is inserted in order to be coupled to a lower smart block,
wherein the lower plate comprises a horizontal communication line that allows the position information to be transmitted to another smart block on the side surface thereof.

10. The smart block of claim 9, wherein the beacon block further comprises a vertical communication line that transmits the reference position information in an upward and downward direction, and the vertical communication line is configured to pass through the main body, the upper plate, and the lower plate.

11. The smart block of claim 10, wherein the beacon block comprises:
a horizontal power line formed on the lower plate in order to transmit electric power to another smart block on a side surface thereof; and
a vertical power line configured to transmit electric power in an upward and downward direction.

12. The smart block of claim 1, wherein the function block comprises:
an input block that generates and transmits various input signals;
an output block that displays various output signals; and
a logic block that generates and transmits a control signal necessary for various logic operations.

13. A smart block control system, comprising:
a smart block configured in a form of a play block implementing various functions by being coupled to each other;
a control block that communicates with the smart block and transmits control information on the smart block; and
a user terminal that communicates with the control block and sets and controls various operations of the smart block,
wherein the smart block is the smart block of claim 1.

14. The smart block control system of claim 13, wherein a function block of the smart block has an identification information, and comprises:
an ID module that transmits the identification information and position information to the control block along with supplying power to the function block;
a pairing module utilized for pairing and connecting function blocks together; and
a function module capable of setting or modifying a specific function.

15. The smart block control system of claim 14, wherein the user terminal comprises:
a pairing control module that transmits a control signal related to the pairing module of the function blocks to be paired and connected together;
a function control module that sets or modifies a specific function for the function module of a specific function block; and
a sequence control module that sets a sequence related to conditions, operation order, and repetition for operations of function blocks when a plurality of function blocks are operated for learning or playing.

16. The smart block control system of claim 14, wherein the user terminal further comprises:
an interface unit that provides a work screen for coding a control command for a control target, and
a coding processing unit that compiles a content coded on the work screen of the interface unit and specifies the control target of a compiled control code.

17. The smart block control system of claim 16, wherein the interface unit comprises:
a first area for displaying a plurality of command entries selectable on the work screen; and a second area where an entry selected in the first area is displayed in a drag and drop manner, and
the coding processing unit comprises:
a conversion processing module for converting an everyday term into a programming language for compilation when the entry of the first area is displayed in everyday terms;
a compilation processing module for compiling a plurality of entries disposed in the second area according to an arrangement order of a plurality of entries disposed in the second area;
an error analysis module for analyzing an error in the control code compiled by the compilation processing module;
an error display module for displaying errors on the work screen when an error exists in the control code as a result of the analysis of the error analysis module; and
a control code transmission module for transmitting the control code of compiled entries to the control target when no error exists in the control code as a result of the analysis of the error analysis module.

18. The smart block control system of claim 16, wherein the coding processing unit comprises a coding target specifying module that specifies a coding target according to a selection of the identification information transmitted by the ID module, wherein the coding target specifying module comprises:
an identification information display module that displays the identification information transmitted by the ID module on the work screen;
an identification information selection module that allows the identification information displayed by the identification information display module to be selected as an object item of an entry or allows the corresponding identification information to be selected as a target of coding when dragged and dropped on the object item; and
an identification information designation module that designates the selected identification information as the coding target for an entry.
